(19) United States
(12) Patent Application Publication
(10) Pub. No.: US 2024/0190114 A1
(43) Pub. Date: Jun. 13, 2024

(54) METAMATERIAL LAMINATE BASED ON POLYMER NANOFIBERS AND METALLIC NANOFIBERS AND METALLIC NANOPARTICLES FOR SENSOR APPLICATIONS

(71) Applicant: University of Central Oklahoma, Edmond, OK (US)

(72) Inventor: Morshed Khandaker, Edmond, OK (US)

(21) Appl. No.: 18/209,190

(22) Filed: Jun. 13, 2023

Related U.S. Application Data
(60) Provisional application No. 63/351,920, filed on Jun. 14, 2022.

(51) Int. Cl. B32B 27/30; B32B 5/02; B32B 27/40; B82Y 40/00; D01D 5/00

(52) U.S. Cl. CPC B32B 27/304; B32B 5/028; B32B 27/40; B32B 2307/202; B82Y 40/00; D01D 5/003; D10B 2401/16

(57) ABSTRACT

A metamaterial laminate having at least the following elements (a) at least one polymer nanofiber mesh having polymer nanofibers embedded with conductive nanoparticles, and (b) at least two films, wherein the polymer nanofiber mesh is sandwiched between the two films. Included are methods of making the laminate. A method to produce cross-direction and multilayers of multi-material nanofibrous polymer using an electrospun technique is presented. The laminate can be used in a method where it is incorporated in a structure and provides stress information by scanning with an electromagnetic radiation to determine physical change within the structure. The nanofiber polymer provides electric conductivity information detected by electrochemical analyzer.

### CROSS REFERENCE TO RELATED APPLICATION

This application claims the benefit of U.S. Patent Application Ser. No. 63/351,920, filed Jun. 14, 2022; the entire disclosure of which is incorporated herein by reference in its entirety.

### FIELD OF THE INVENTION

The present invention generally relates to the field of composite material.

### BACKGROUND

Vehicles, aircrafts, other locomotion devices and building platforms are increasingly composed of composite materials because they are lighter and less expensive than metals, but their failure is more difficult to predict or detect. When high strain regions due to applied loading on the above structure go undetected catastrophic failure, loss of property can occur. Therefore, a nondestructive method to detect and monitor the condition of opaque composite materials is of critical importance to avoid these incipient failures.

As will be realized from the forgoing, composite materials are widely used in vehicles (for example ships and airplanes) and other industrial engineering sectors, which has created a need for tools to monitor their structural health and warn of incipient failure. Strain field measurement of opaque composite materials is indispensable for structural health monitoring, including vehicles (ships, aircrafts, and other land, sea and air locomotion devices, whether manned or unmanned), buildings or concrete structures.

Several techniques have been tried for mapping strain fields in visually opaque structural composites, including embedded sensors, laser surface mapping, acoustic transducers, X-ray imaging, and terahertz imaging concepts. The traditional optical polarimetric techniques for measuring photoelasticity are problematic due to composite material's opacity. It is challenging to map the strain field as stress-induced birefringence produces weak refractive index anisotropies at terahertz frequencies. Many of the above techniques can identify damaged regions at the composite material interface. Still, none can recover evidence of prior incidents that may precipitate future composite failure if the local stress exceeds a critical threshold.

Additionally, current methods for detecting wound infections are cumbersome and time-consuming, often requiring the wound to be left exposed for several seconds or even up to an hour. This exposure can compromise the wound's healing environment and potentially lead to further infection. There is a need for a tool that allows for active infection detection without compromising the wound's healing environment.

### BRIEF DESCRIPTION OF THE FIGURES

Various aspects of the present disclosure are illustrated in the following detailed description and accompanying figures.

FIGS. 1A, 1B, 1C and 1D are charts illustrating the measured reflection intensity vs. strain value for each of five interactions (pulling to a distance and reversing to the initial position).

FIG. 2 is an illustration of measured strain map of a PP laminated sample with a top portion covered by TPU-Ni and bottom only PP.

FIG. 3 is an illustration of the measured strain map of a PP laminated sample including a TPU-Ni mesh.

FIG. 4 is a schematic illustration of an electrospin process in accordance with this disclosure.

FIG. 5 is a schematic illustration of another electrospin process in accordance with this disclosure.

### DETAILED DESCRIPTION

Particular aspects of the present invention and/or disclosure are described in greater detail below. The terms and definitions provided herein control if in conflict with terms and/or definitions incorporated by reference.

As used herein, the terms “comprises,” “comprising:” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts have been exaggerated to better illustrate details and features of the present disclosure.

As used herein and in the appended claims, the following terms and phrases have the corresponding definitions set forth below.

“Metamaterial” refers to a material made from assemblies of multiple elements fashioned from composite materials such as metals and plastics. These materials have components typically in arranged in repeating patterns, at scales that are smaller than the wavelengths of the phenomena they influence. Metamaterials derive their properties not from the properties of the base materials, but from their newly designed structures. In this disclosure, the scales and patters are generally designed for terahertz radiation scanning, that is blocking, absorbing, enhancing, or bending waves, in the terahertz frequency to analyze stress.

“Nanofibers” generally refer to fibers (more specifically herein, to polymer fibers) with a diameter on the nanometer scale (1 nm to 1 μm) but more typically, of less than about 500 nm, less 200 nm or less than 100 nm. Nanofibers have an aspect ration (the ratio between length and width) of at least 50. Typically, such nanofibers can have a length of greater than 1 μm and can extend up to centimeters in length.

“Nanoparticles” generally refer to particles (more specifically herein, to metal particles) with an overall size (diameter, length, width, etc.) on the nanometer scale. Thus, typically, the lengths in three dimensions will be in the 1 nm to 1 μm. Typically, the particles will have a low aspect ratio of less than 50, more typically, less than 10 or less than 5.

“Terahertz radiation”—also known as submillimeter radiation, terahertz waves, tremendously high frequency—consists of electromagnetic waves within the band of frequencies from 0.1 to 3 terahertz (THz). Accordingly, wavelengths of radiation in the terahertz band correspondingly range from about 1 mm to about 0.1 mm (100 μm). This band of electromagnetic radiation lies within the transition region between microwave and far infrared.

Aspects of this disclosure are directed to systems, apparatus and process around the use of metamaterial laminates with a strain-dependent polarimetric response. These laminates may be adhered onto or embedded within a composite, and their polarimetric response may be spectroscopically probed in transmission or reflection geometries. Spatially mapping the polarimetric signature of the metamaterial laminate will reveal the local strain fields within the composite, which can be permanently recorded if the metamaterials break under sufficient stress. Indeed, metamaterial arrays or layers of metamaterial laminates may be designed with different threshold stress responses, so that the amount of strain historically experienced by the composite may be recovered and spatially mapped, thus revealing regions of incipient failure. For other applications which require dynamic monitoring of evolving composite strain fields in real time, self-healing deformable metamaterials can be used because they can record current levels of strain while reversibly returning to an unstrained signature when the stress is released. Metamaterials operating within the terahertz spectral region (0.1-3 THz) provide a nearly optimal compromise of spatial resolution and material penetration depth in a manner that depends on the unique properties of the composite host. Application of these metamaterials for non-destructive testing could become a transformative approach to maintenance that will enable longer operating times for systems beyond the current conservative maintenance schedules, increase operational readiness, and at the same time increase safety and confidence.

Further aspects of the invention relate to new and novel methods for detecting wound infections without exposing the wound and thus compromising the wound's healing environment, which can potentially lead to further infection. Multi-layers of this disclosure's nanofiber-based sensors can be placed among the gauze when a wound is initially dressed so that the nanofiber-based sensors can collect data such as pH, pressure, moisture, and temperature. The dressing can also include an integrated RFID or WiFi module for wireless data collection. The development process of multilayers and multi-material nanofibrous polymer involves designing and testing the responses of the sensors in infected and healthy wound environments to establish a reference point for detecting infections.

For example, various metamaterial nanofiber material of this disclosure can be used for temperature, pH, pressure and humidity sensors to optimize sensing area size in wound infection detection. The aim is to create a small, reliable, and user-friendly device that can be placed on top of a wound to detect whether it is infected and wirelessly transfer that data to a phone or other device. Such multi-sensors accommodation in the bandage could have the potential impact in the field of wound infection detection and treatment.

The present disclosure addresses the above needs through metamaterial laminates adhered onto or embedded within an opaque composite host, whose polarimetric response is sensitive to the local strain and may be mapped in reflection or transmission geometries. For example, a metamaterial laminate can comprise or have at least the following elements (a) at least one polymer nanofiber mesh having polymer nanofibers embedded with conductive nanoparticles, and (b) at least two films, wherein the polymer nanofiber mesh is sandwiched between the two films. The films can be polymer films but in some uses can be films formed from metallic or ceramic paste or fiber mesh. In some embodiments, metamaterial laminate will include multi-layers of polymer nanofiber mesh sandwich between the films, which can for example comprise meshes with different fiber orientations, or differ polymer nanofibers and or different conductive nanoparticles. In some embodiments a mesh (or multi-layer of mesh) and a further component can be sandwiched between the films. For example, an insulating material can be sandwiched between layers of polymer nanofiber mesh, and/or a polymer film can be sandwiched with the mesh between the films.

In some embodiments, a plurality of metamaterial laminates is used. Typically, these plurality of metamaterial laminates are stacked and fused together so that each metamaterial laminate forms a metamaterial layer in the resulting metamaterial stack. For example, the metamaterial stack can be made from laminates having the polymer nanofiber unidirectional aligned. In some cases, the metamaterial stack will have different alignment of the layer; thus, the uni-direction of one metamaterial layer will not align with one of the uni-direction of another of the layers. For example, these two layers can have their uni-directional be orthogonal. In this manner—as well as in other changes such as nanoparticle size, thickness, and composition—each metamaterial layer can have different responses, such as different threshold stress responses, so when the strain exceeds a specific limit value, the electromagnetic characteristic value will change, or so as to have reversibly deformable characteristics for quantitatively recovering the amount of strain currently experienced by the composition.

As indicated above, the composition of the metamaterial laminates can vary. For example, the polymer nanofiber mesh can be formed from polymer nanofibers selected from the group consisting of polytetrafluoroethylene, polyvinyl chloride, polyurethane, and combinations thereof. For example, the conductive nanoparticles can be selected from the group consisting of graphene, gold, nickel, aluminum, and combinations thereof. For example, the two polymer films are formed from polymers selected from the group consisting of polypropylene, polydimethylsiloxane, parylene and combinations thereof.

Two types of metamaterial laminates satisfied by the current disclosure are (a) a first type of those with permanently severable break junctions for quantitatively recovering the amount of strain experienced historically, and (b) a second type of those that are reversibly deformable for quantitatively recovering the amount of strain experienced by the composite relative to time. These metamaterial laminates, either singularly or in a metamaterial stack can be incorporated into current structures using conventional composites so as to provide stress information. For example, they can be incorporated in composite materials used in vehicles and other industrial engineering sectors (buildings, etc. or even concrete structures).

Accordingly, the present disclosure embodiments also relate to the design and fabrication of metamaterial laminates made of electrospun nanofiber mesh embedded with nanoparticles and process development for 3D strain mapping of an opaque composite material using the metamaterial. For example, the metamaterial laminates of this disclosure can be prepared by a process comprising electrospinning a polymer solution containing conductive nanoparticles so as to produce a polymer nanofiber mesh embedded with conductive nanoparticles.

A typical electrospinning system can contain a syringe (plastic/glass), metallic needle, high-power voltage supply (0-50 kV), a collector (drum, parallel wire/disc, flat plate), and a syringe pump. The high voltage power is supplied between the needle tip and the collector, the positive electrode being connected to the needle tip and the ground connected to the collector. More than 5 kV is usually applied, but this can vary depending upon the characteristics of the polymer solution. This electric voltage causes evaporation of the solvent and tends to alter the stability of the solution by charging the solution, and then repulsing action takes place. This would force the solution to enter a bending stage by stretching the solution jet. A collector can collect the fiber deposited in different forms. The collector can be a rotating drum or a set of parallel plate electrodes depending upon the applications of the fiber.

For example, in the below examples, nanofiber membranes were made by alternative polarity of syringe and a set of parallel plate electrodes. The resulted multilayered nanofiber cloth (mesh) physical and electrical characteristic were evaluated using electrochemical (Cyclic voltammetry) analyzer. The composite material made from such cloth (mesh) can be used for various sensing application including wound detection sensor based on the pH, temperature, moister and pressure readings.

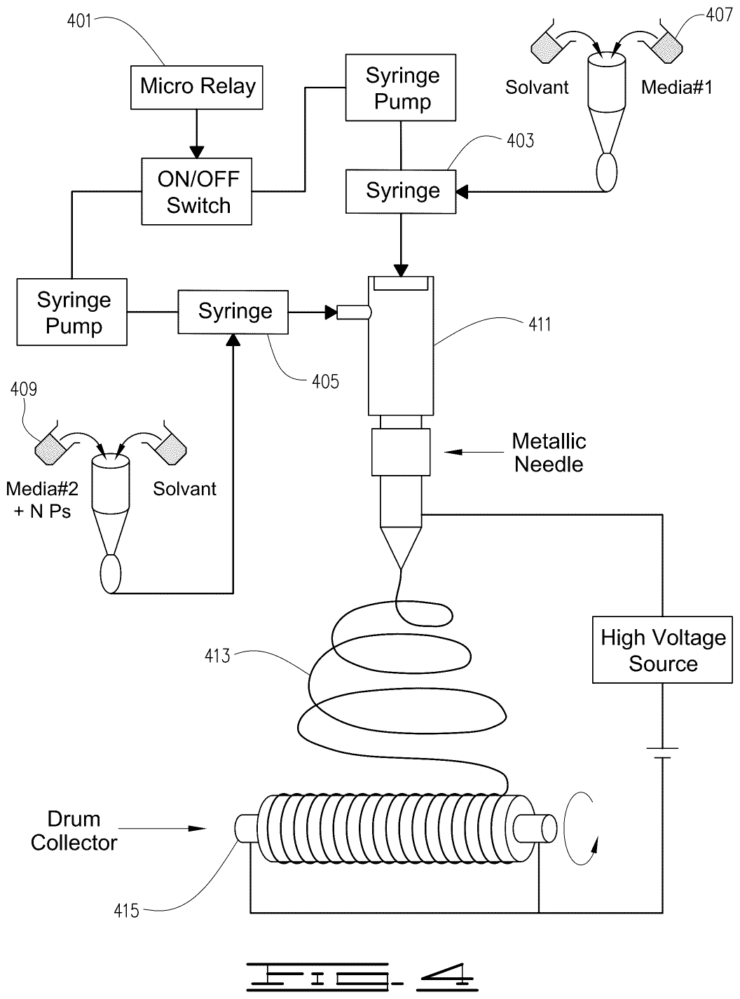

For example, multilayers of fibers can be deposited on a drum collector automatically using a micro relay controller, where the first layer material is different from the second layer (FIG. 4). Micro relay controller 401 can alternatively power on/off syringes 403 and 405 producing the alternating polymer layers from media #1 407 and media #2 and 409. For example, two motors in the syringe pump that can be operated by the micro relay controlled on/off switch to flow alterative solution passing through the charged needle during the electrospinning process. Although illustrated with only Media #2 having conductive nanoparticles, either, both or neither media can have conductive nanoparticles. However, typically at least one of the medias will include conductive nanoparticles. If both have conductive nanoparticles, the particles can be different types of conductive nanoparticle. Also, the polymer of each media can be different or the same. The media from syringes 403 or 405, is introduced into electrospin apparatus 411 and the resulting nanofiber 413 is collected on drum collector 415. It will be realized that the system can also be used to produce a mesh out of single media as opposed to two differing media.

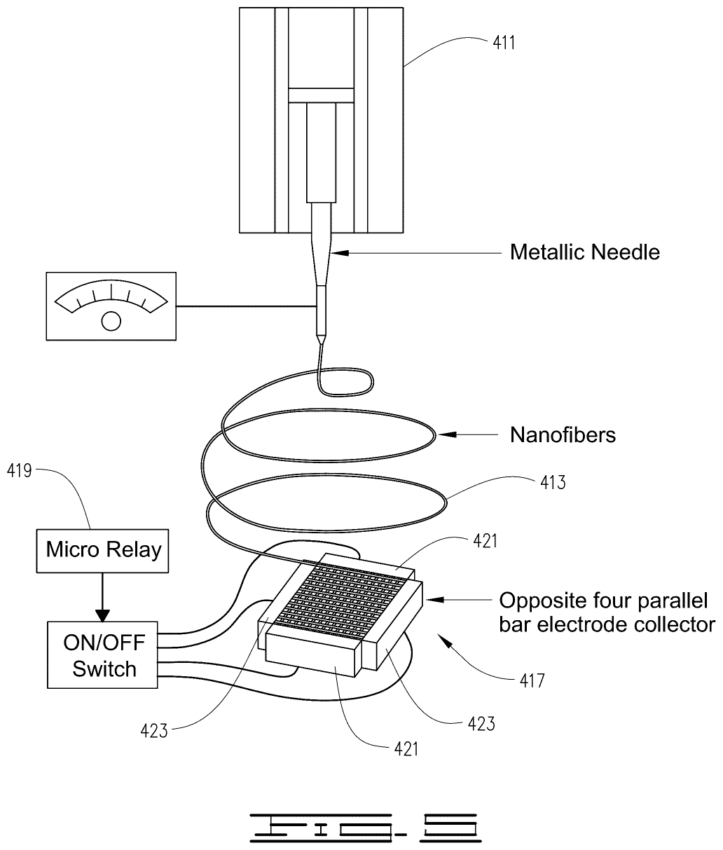

FIG. 5 illustrates production of a bi-directional fiber mesh. A similar system can be used to introduce media #1 and/or media #2 to the electrospin apparatus 411. The produced nanofiber 413 can be deposited so as to produce a bi-direction fiber mesh. The fibers can be deposited on a collector 517 automatically using a micro relay controller 519, where the direction of fiber collection is ˜90° between two adjacent layers. Two sets of parallel plates 521 and 523 can be charged in an alternating period to a produce bi-direction fiber mesh. When one set of parallel plates is charged, the other sets is uncharged and vice versa. In doing so, the bidirectional fibers are deposited on the collector 517.

For example, a nanofiber mesh has been produced by randomly distributing a TPU-Ni composite nanofiber into a wide range of 240-600 nm in a diameter onto the drum collector (FIG. 4). The morphology of the TPU-Ni composite showed the deposition of particles into the nanofibers. Pristine TPU is an insulating polymer. Imaging of the nanofiber mesh confirms that Ni nanoparticles were incorporated in TPU nanofiber matrix by direct imbedding in the nanofiber and entrapping in the nanofiber matrix. Therefore, the currently described process can improve the electrical conductivity of the insulating material.

After electrospinning, the process can include pressing the nanofiber mesh between to polymer films to produce a metamaterial laminate. Additionally, the process can include stacking and fusing together two more of the metamaterial laminates so that each metamaterial laminate forms a metamaterial layer in the resulting metamaterial stack.

For example, a method of using can comprise using the metamaterial laminate or the metamaterial stack within a composition, such as a composite composition. The composition can then be used in a structure. Thereafter, the structure can be scanned with a terahertz scanning instrument to determine strain distribution within the structure.

Thus, in accordance with the above, disclosed herein are embedded electromagnetic metamaterials sensitive to applied stresses and operating in the terahertz regime to measure the strain field. For example, the novel metamaterial can be composed of electrospun nanofiber mesh sandwiched between two protective films. Utilizing terahertz resonant elements on a highly elastomeric substrate, a continuous tunability of the resonance frequency will be achieved with a small applied strain. The combination of high THz modulation, high strain operation, and flexibility in the electrospun nanofiber polymer allow applications in wearable and intelligent THz dynamic devices.

For example, the novel metamaterial can be a flexible THz modulation device based on conductive polymer composites composed of polyurethane nanofiber and conductive metal (for example, nickel or alternatively a conductive non-metal such as graphite or carbon) nanoparticles laminated by polypropylene films. A typical electrospun nanofiber system can be used to produce the conductive polymer. A hot press can be used to make the laminated structure. The developed laminated structure can be embedded with an opaque composite to detect and map the strain of opaque composite under loading by creating an empirical model correlating optical response with the local strain.

The metamaterial laminates can be adhered onto or embedded within a variety of opaque host materials of practical interest for vehicular, building platforms and other uses. The opaque host material includes metal, ceramics, polymer, and composite. A terahertz (T-ray) scanning instrument can be used for various electrical and optical characterizations. The metamaterial laminates are able to map a surface for its strain distribution both on the surface and below the surfaces in a nondestructive fashion using the scanner when a load is applied to the composite. Both polarization and non-polarization-dependent strain measurements are possible from the current metamaterial laminates.

For example, in some embodiments, the metamaterial laminate is a single-layer metamaterial laminate with nickel nanoparticles embedded in polyurethane nanofiber membrane and polypropylene films. Spatially mapping the reflection intensity of the metamaterial laminate revealed the local strain fields within the composite. In embodiments, the laminate includes metamaterial arrays or multi-layers of metamaterial laminates designed using multi-layers and multi-materials nanofiber mesh. Each layer with different threshold stress responses so that the amount of strain historically experienced by the composite may be recovered and spatially mapped.

In embodiments, polyvinyl chloride (PVC) can be alternative to polyurethane for making the metamaterial. Metallic nanopowders (such as nickel, aluminum and silver), graphene, and carbon nanotubes can be combined with PVC and thermoplastic polyurethane (TPU) nanofibers to produce the metamaterials. Kapton polyimide, polyethylene naphthalate (PEN), and polydimethylsiloxane (PDMS) can be used as the laminated film for making the metamaterial composite. Optionally, metallic or ceramic paste can be used to form the film, or fiber mesh can be used to form the film.

Optionally, a hot compressive press technique can be used to sandwich nanofiber membrane between two polypropylene films. Optionally, a variable thickness of polypropylene films can be coated on top of the nanofiber membranes by direct spin coating of polypropylene melted solution.

Typically, the polymer nanofibers will be synthesized by electrospinning technology to produce terahertz-sensitive metamaterials. However, an extrusion-based 3D-printing method can be used to produce the polyurethane membrane. However, using electrospun nanofibers membrane is currently preferred due to the higher aspect ratio, larger surface area, higher porosity, lighter weight, and relatively better mechanical stability compared to 3D-printed membrane.

### Examples

Thermoplastic polyurethane (TPU) was used to form the polymer mesh and 2,2,2-Trifluoroethanol (TFE), dimethylformamide (DMF), tetrahydrofuran (THF) and trichloromethane (TCM) were used as solvents to dissolve TPU. Nickel Nanoparticles (<100 nm) were used. Polypropylene films of thickness 25 micron were purchased. These materials and chemicals were used as received without further purification.

Laminates were prepared using the following steps.

### Step 1: Polymer Solution Preparation.

TCM and TFE were mixed at the volume ratio of 5:5. DMF and THF were mixed at the volume ratio of 5:5 too. Then, the same amount of TPU was added to every mixture to prepare a spinning solution at a concentration of 5%. The mixture was stirred using a magnetic bar until the solution was uniform and free of bubbles. Ni nanopowder was mixed with the solution at a concentration of 1%.

### Step 2: Uni- and Bi-Direction TPU and TPU/Ni Nanofibers Preparation.

Uni- and bi-direction TPU and TPU/Ni nanofibers were prepared using an electrospinning apparatus. In short, to produce unidirectionally aligned fiber, the vertical drum extraction method was used. A DC motor with the drum was mounted on a precision linear stage (Newport Corporation., model #426). The motion of the stage was controlled by a linear actuator (Newport Corporation., model #LTA-HS). TPU fiber solution was ejected from the infusion pump glass syringe (Harvard Apparatus, mode #PHD ULTRA) via charged needle (23 G blunt needle, aluminum hub, 1″ length, model #BX 25). The fibers were deposited on a grounded custom-made drum collector. The needle was charged by a high voltage power source (Gamma High Voltage Research, Inc., model #ES 30 series). Substrates were attached to the drum using double-sided tape.

For the fabrication of the bidirectional method, the same vertical electrospinning unit was used. Two parallel plates were used as the ground collector instead of the drum collector. The plates were mounted on acrylic, an insulating material. A substrate can be placed in between the parallel plates. During the fiber production, four plates were charged so that two parallel plates were charged for a certain time, keeping the other two plates uncharged. The polarities on the parallel plate sets were changed using a micro relay-controlled switch that changes the collected fiber's direction on the substrate.

This innovation successfully produced TPU and TPU/Ni nanofiber meshes. The applied voltage of the electrospinning setup for TPU and TPU/Ni nanofiber production was 18 kV. The tip-to-collector distance was 15 cm. The feeding rate was set at 1 mL/h. All samples were prepared at room temperature. The TPU and TPU/Ni nanofiber meshes obtained from electrospinning were dried in the electrospun setup substrate for 48 h to remove the residual organic solvent.

### Step 3: Production of Polymer Composites Based on Nanofibers (TPU and TPU/Ni) and Polypropylene Films.

A variable dimension fiber mesh coupon was cut from the substrate and placed between two polypropylene films. A hot press was used to make the polypropylene laminated TPU and TPU/Ni composite by using the hot plate temperature of approximately 120 and applied pressure of 4000 Psi.

This innovation successfully produced polypropylene laminated TPU and TPU/Ni Nanofiber Meshes.

Step 4: Strain mapping using THz spectrometer.

A polarized or non-polarized Terahertz spectrometer was used to rapidly map the locally-sensed strain fields. The laminated metamaterial structure was designed such that it can provide a quantitative estimate of the achievable spatial resolution and strain sensitivity for a variety of opaque host materials.

The current innovation successfully assessed the reflection intensity with strain of our laminated metamaterial composite using a custom-made mechanical setup. A terahertz spectrometer continuously measured the reflection intensity of the metamaterial during pulling the material from an initial stretched position and releasing it to the original position. A linear relationship between reflected intensity and the linear strain was observed from the assessment, which validated that the current designed and fabricated laminated metamaterial can be used as a terahertz sensitive stress sensor.

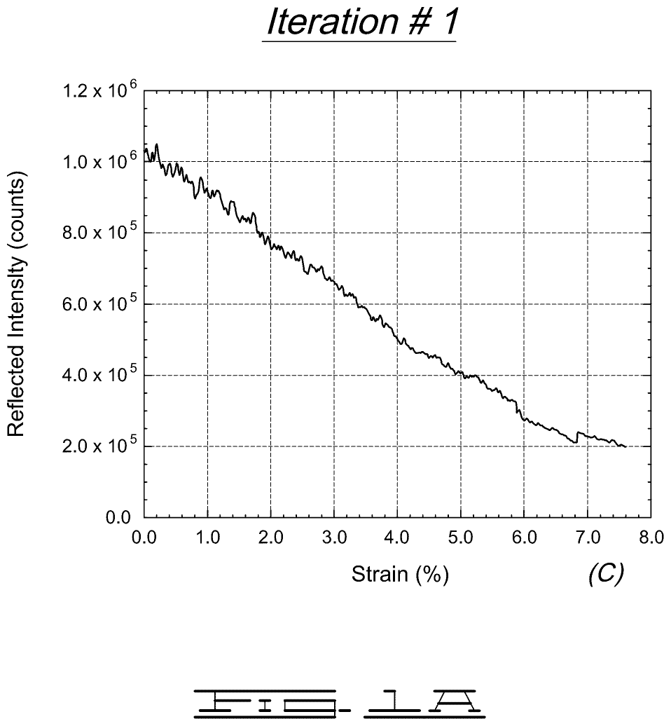

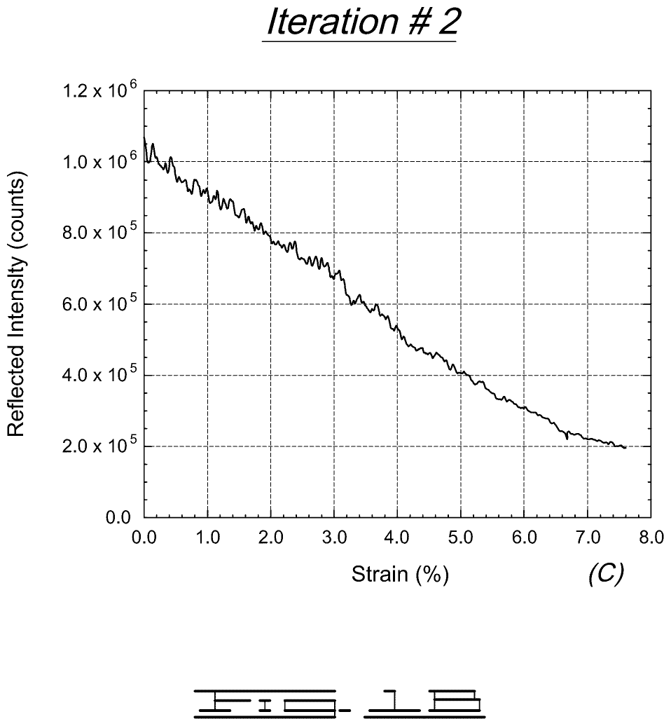

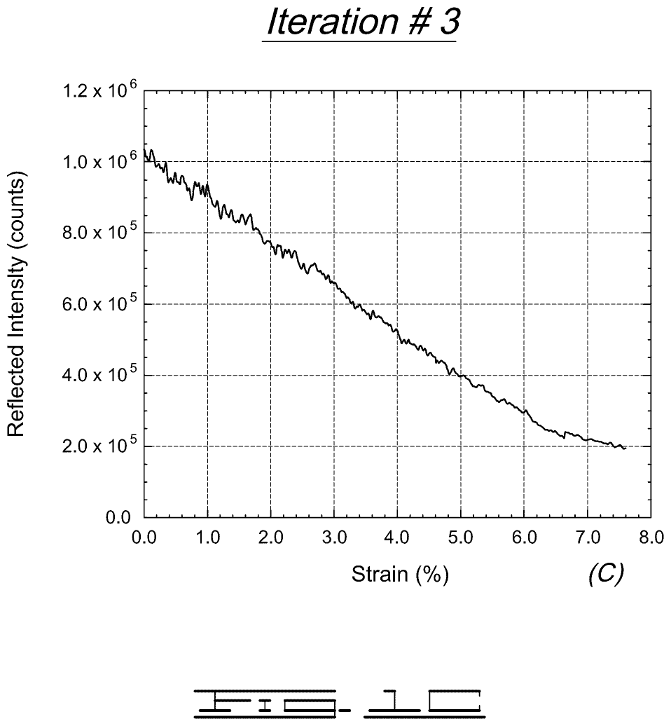

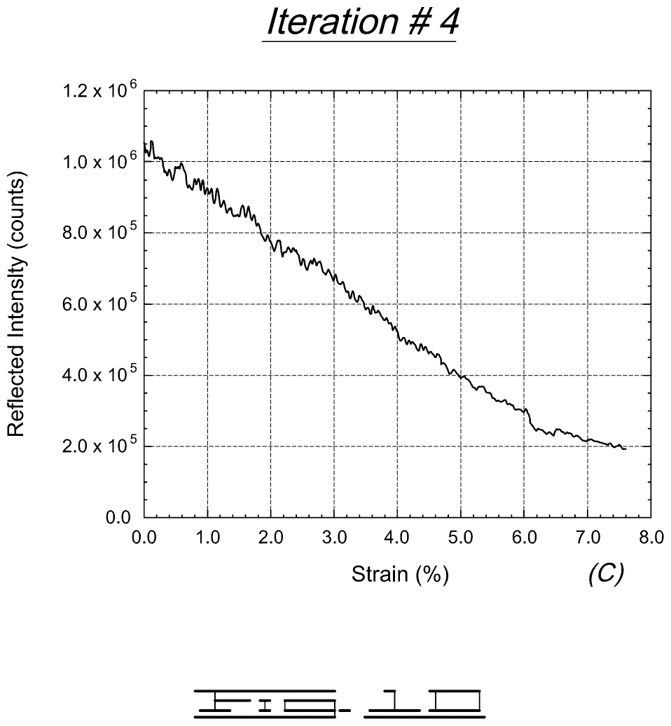

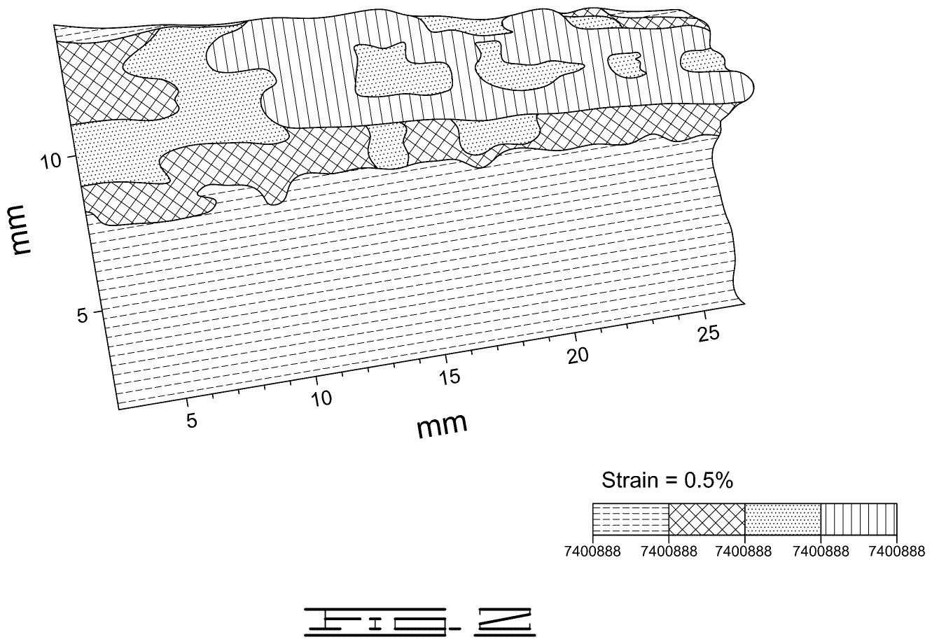

The results of FIGS. 1A-D and FIG. 2. FIGS. 1A-D are charts illustrating the measured reflection intensity vs. strain value for each of five interactions (pulling to a distance and reversing to the initial position). The reflective intensity of the specimen was measured at every 0.1-second interval and plotted against the calculated strain value. This was done for four iterations. FIGS. 1A-D presents the results of the quantitative assessment of reflection intensity with strain using Applied Research & Photonics, Inc.'s (ARP) terahertz spectrometer. The fluctuations in the intensity indicated the rise of porosity with increase strain. The fluctuation was higher after 2% of strain. More photons escaped via transmission through the porosity, thus, decreasing the reflected intensity with strain increase. A clear relation between reflected intensity and % of strain is visible from this plot. A linear relationship between reflected intensity and linear strain was observed for each iteration. Thus, this assessment validates that the current design and fabricated laminated metamaterial can be used as terahertz sensitive stress sensor.

FIG. 2 is an illustration of measured strain map of a PP laminated sample with a top portion covered by TPU-Ni and bottom only PP. There is a clear difference in the strain map observed between the material under the same strain. The image was produced by ARP 3-axis scanner and their camera-less imaging algorithm.

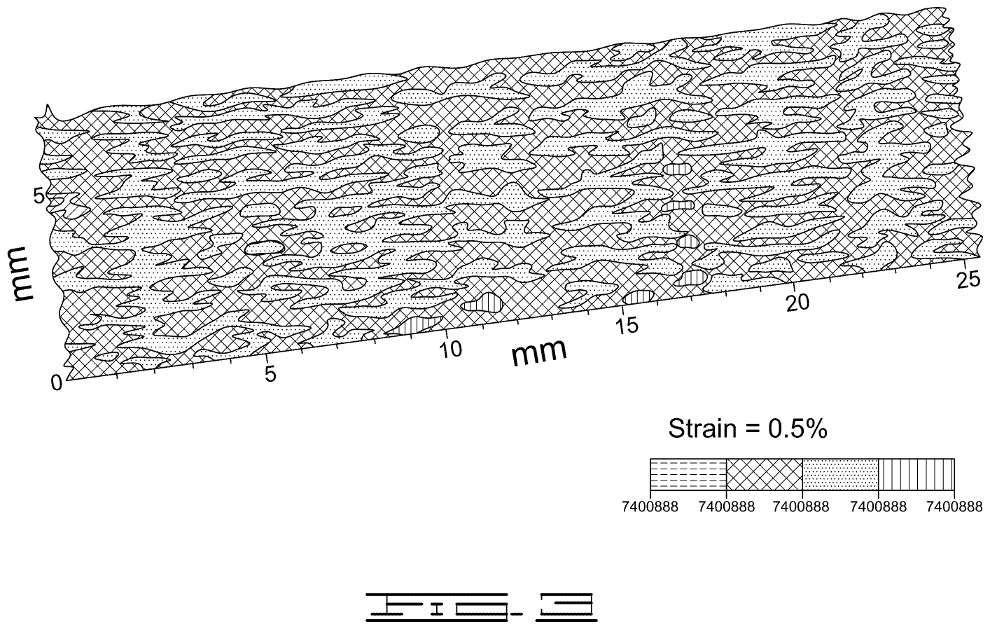

FIG. 3 illustrate the surface of the TPU-Ni from image scanning over an arbitrary area using ARP Inc. continuous-wave T-ray scanning reflectometer (CWTSR) measurement system. ARP's camera-less imaging algorithm generated the image of the area. The strain map thus generated is shown in FIG. 3. The strain map clearly shows the uneven strain produced on the TPU-Ni.

The permittivity, refractive index, and elastic modulus for single layers of nanofiber can be measured experimentally, then use an analytical model for composite material to calculate the refractive index of multilayers polymer membrane for developing metamaterial strain sensor by correlating refractive index with the strain change (FIG. 3).

A clear relation between reflected intensity and % of strain is visible from this plot. FIG. 3 shows the surface of the TPU-Ni from scanning over an arbitrary area using ARP continuous-wave T-ray scanning reflectometer (CWTSR) measurement system. ARP's camera-less imaging algorithm generated the image of the area. The strain map thus generated is shown in FIG. 3. The strain map clearly shows the uneven strain produced on the TPU-Ni.

Additionally, meshes produced in these examples included ones with nanofibers randomly distributed into a wide range of 240-600 nm in a diameter from the dram collector. The morphology of the TPU-Ni composite showed the deposition of particles into the nanofibers. Pristine TPU is an insulating polymer. Image analysis of the meshes confirmed that Ni nanoparticles can be incorporated in TPU nanofiber matrix by direct imbedding in the nanofiber and entrapping in the nanofiber matrix. Therefore, our developed process can improve the electrical conductivity of the insulating material.

Certain embodiment of this disclosure will be better understood by reference to the following numbered paragraphs.
1. A composition comprising:
at least one metamaterial laminate comprising:
   at least one polymer nanofiber mesh having polymer nanofibers embedded with conductive nanoparticles; and
   at least two films, wherein the polymer nanofiber mesh is sandwiched between the two films. Optionally, the films can be polymer films, or optionally the films can be formed from metallic or ceramic paste or fiber mesh. Optionally, the metamaterial laminate will include multi-layers of the polymer nanofiber mesh sandwich between the films, which can for example comprise meshes with different fiber orientations, or differ polymer nanofibers and or different conductive nanoparticles. Optionally, the mesh (or the multi-layer of mesh) and a further component can be sandwiched between the films. For example, an insulating material can be sandwiched between layers of polymer nanofiber mesh, and/or a polymer film can be sandwiched with the mesh between the films.
2. The composition of paragraph 1, wherein polymer nanofiber mesh is formed from polymer nanofibers selected from the group consisting of polytetrafluoroethylene, polyvinyl chloride, polyurethane, and combinations thereof.
3. The composition of either paragraph 1 or 2, wherein the conductive nanoparticles are selected from the group consisting of graphene, gold, nickel, aluminum, and combinations thereof.
4. The composition of any preceding paragraph, wherein the films are polymer films formed from polymers selected from the group consisting of polypropylene, polydimethylsiloxane, parylene and combinations thereof.
5. The composition of any of paragraphs 1 to 4, further comprised of a plurality of metamaterial laminates, wherein the metamaterial laminates are stacked and fused together so that each metamaterial laminate forms a metamaterial layer in the resulting metamaterial stack.
6. The composition of paragraph 5, wherein the metamaterial stack includes a first metamaterial layer that has first polymer nanofiber mesh with the polymer nanofiber being unidirectional and a second metamaterial layer that has a second polymer nanofiber mesh with the polymer nanofiber being uni-directional, and wherein the uni-direction of the first polymer nanofiber mesh does not align with the uni-direction of the second polymer nanofiber mesh.
7. The composition of either paragraph 5 or 6, wherein each metamaterial layer has different threshold stress responses, so when the strain exceeds a specific limit value, the electromagnetic characteristic value will change.
8. The composition of any of paragraphs 5 to 7, wherein the metamaterial layers vary in thickness and composition so as to have reversibly deformable characteristics for quantitatively recovering the amount of strain currently experienced by the composition.
9. A method comprising:
electrospinning a polymer solution containing conductive nanoparticles so as to produce a polymer nanofiber mesh embedded with conductive nanoparticles; and
pressing the nanofiber mesh between two films to produce a metamaterial laminate.
10. The method of paragraph 9, further comprising:
using the metamaterial laminate within a structure, and
scanning the structure with a terahertz scanning instrument to determine strain distribution within the structure.
11. The method of paragraph 9, wherein the metamaterial laminate is included in a composition such that the layer has reversibly deformable characteristics for quantitatively recovering the amount of strain currently experienced by the composition.
12. The method of any of paragraphs 9 to 11, wherein the polymer solution comprise a polymer selected from the group consisting of polytetrafluoroethylene, polyvinyl chloride, polyurethane, and combinations thereof.
13. The method of any of paragraphs 9 to 12, wherein the conductive nanoparticles are selected from the group consisting of graphene, gold, nickel, aluminum, and combinations thereof.
14. The method of any of paragraphs 9 to 13, wherein the films are polymer films formed from one or more polymers selected from the group consisting of polypropylene, polydimethylsiloxane and parylene.
15. The method of any of paragraphs 9 and 11 to 14, further comprising stacking and fusing together two more of the metamaterial laminates so that each metamaterial laminate forms a metamaterial layer in the resulting metamaterial stack.
16. The method of paragraph 15, wherein the metamaterial stack is included in a composition such that the metamaterial stack has reversibly deformable characteristics for quantitatively recovering the amount of strain currently experienced by the composition.
17. The method of paragraph 16, further comprising:
using the metamaterial stack within a structure, and
scanning the structure with a terahertz scanning instrument to determine strain distribution within the structure.
18. The method of paragraph 17, wherein each metamaterial layer has different threshold stress responses, so when the strain exceeds a specific limit value, the electromagnetic characteristic value will change, and further comprising, recording the change for quantitatively accessing the amount of strain experienced historically by the composition.

Further, the compositions and methods of the above numbered paragraphs include embodiments with the following.

Embodiments where the nanofiber mesh is cross-direction fiber made an electrospun nanofiber technique where bi-direction fibers can be produced directly by changing the polarity of the two sets of parallel plates electrodes.

Embodiments where alternative layers of nanofiber mesh in the metamaterial laminates can be produced directly by periodically turning on and off syringe pump using a microcontroller.

Embodiments where the nanofiber mesh is cross-direction fiber made an electrospun nanofiber technique where bi-direction fibers can be produced directly by changing the polarity of the two sets of parallel plates electrodes.

Embodiments where the alternative layers of nanofiber mesh in the metamaterial laminates can be produced directly by periodically turning on and off syringe pump using a microcontroller.

Embodiments where laser engraving of metamaterial laminates or multilayers nanofiber to produce working and reference electrodes for electrochemical screen-printed sensors fabrication.

Embodiments further comprising using the metamaterial laminate or multilayers nanofiber structure to analyze the structure by cyclic voltammetry (CV) electrochemical techniques with ferri/ferrocyanide redox couple to assess the efficiency of the designed electrode in detecting chemical compounds.

Embodiments where nanofiber-based metamaterial laminates with two different layers, first layer is working electrode and second layer is reference electrode assembled for sensor application.

Embodiments further comprising various nanofiber-based metamaterial laminated sensor worked on a flexible electronics platform to detect wound infection.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments described herein. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges, some lower limits listed may be greater than some upper limits listed. One skilled in the art will recognize that the selected subset will require the selection of an upper limit in excess of the selected lower limit.

Therefore, the present treatment additives and methods are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently. “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A composition comprising:
at least one metamaterial laminate comprising:
at least one polymer nanofiber mesh having polymer nanofibers embedded with conductive nanoparticles; and
at least two films, wherein the polymer nanofiber mesh is sandwiched between the two films.

2. The composition of claim 1, wherein:
the polymer nanofiber mesh is formed from polymer nanofibers selected from the group consisting of polytetrafluoroethylene, polyvinyl chloride, polyurethane, and combinations thereof; and
the conductive nanoparticles are selected from the group consisting of graphene, gold, nickel, aluminum, and combinations thereof.

3. The composition of claim 1, wherein the films are selected from the group comprising polymer films and films formed from metallic paste, ceramic paste or fiber mesh, and combinations thereof.

4. The composition of claim 3, wherein the films are polymer films and the polymer films are formed from polymers selected from the group consisting of polypropylene, polydimethylsiloxane, parylene and combinations thereof.

5. The composition of claim 1, further comprised of a plurality of metamaterial laminates, wherein the metamaterial laminates are stacked and fused together so that each metamaterial laminate forms a metamaterial layer in the resulting metamaterial stack.

6. The composition of claim 5, wherein the metamaterial stack includes a first metamaterial layer that has first polymer nanofiber mesh with the polymer nanofiber being unidirectional and a second metamaterial layer that has a second polymer nanofiber mesh with the polymer nanofiber being uni-directional, and wherein the uni-direction of the first polymer nanofiber mesh does not align with the uni-direction of the second polymer nanofiber mesh.

7. The composition of claim 5, wherein each metamaterial layer has different threshold stress responses, so when the strain exceeds a specific limit value, the electromagnetic characteristic value will change.

8. The composition of claim 5, wherein the metamaterial layers vary in thickness and composition so as to have reversibly deformable characteristics for quantitatively recovering the amount of strain currently experienced by the composition.

9. The composition of claim 5, wherein:
the polymer nanofiber mesh is formed from a polymer selected from the group consisting of polytetrafluoroethylene, polyvinyl chloride, polyurethane, and combinations thereof;
the conductive nanoparticles are selected from the group consisting of graphene, gold, nickel, aluminum, and combinations thereof; and
the films are polymer films formed from polymers selected from the group consisting of polypropylene, polydimethylsiloxane, parylene and combinations thereof.

10. A method comprising:
electrospinning a polymer solution containing conductive nanoparticles so as to produce a polymer nanofiber mesh embedded with conductive nanoparticles; and
pressing the nanofiber mesh between two films to produce a metamaterial laminate.

11. The method of claim 10, further comprising:
using the metamaterial laminate within a structure, and
scanning the structure with a terahertz scanning instrument to determine strain distribution within the structure.

12. The method of claim 10, wherein the metamaterial laminate is included in a composition such that the layer has reversibly deformable characteristics for quantitatively recovering the amount of strain currently experienced by the composition.

13. The method of claim 10, wherein:
the polymer solution comprise a polymer selected from the group consisting of polytetrafluoroethylene, polyvinyl chloride, polyurethane, and combinations thereof; and
the conductive nanoparticles are selected from the group consisting of graphene, gold, nickel, aluminum, and combinations thereof.

14. The method of claim 10, wherein the films are selected from the group comprising polymer films and films formed from metallic paste, ceramic paste or fiber mesh, and combinations thereof.

15. The method of claim 14, wherein the films are polymer films formed from one or more polymers selected from the group consisting of polypropylene, polydimethylsiloxane and parylene.

16. The method of claim 10, further comprising stacking and fusing together two more of the metamaterial laminates so that each metamaterial laminate forms a metamaterial layer in the resulting metamaterial stack.

17. The method of claim 16, wherein the metamaterial stack is included in a composition such that the metamaterial stack has reversibly deformable characteristics for quantitatively recovering the amount of strain currently experienced by the composition.

18. The method of claim 17, further comprising:
using the metamaterial stack within a structure, and
scanning the structure with a terahertz scanning instrument to determine strain distribution within the structure.

19. The method of claim 18, wherein each metamaterial layer has different threshold stress responses, so when the strain exceeds a specific limit value, the electromagnetic characteristic value will change, and further comprising, recording the change for quantitatively accessing the amount of strain experienced historically by the composition.

20. The method of claim 19, wherein:
the polymer solution comprises a polymer selected from the group consisting of polytetrafluoroethylene, polyvinyl chloride, polyurethane, and combinations thereof;
the conductive nanoparticles are selected from the group consisting of graphene, gold, nickel, aluminum, and combinations thereof; and
the films are polymer films formed from one or more polymers selected from the group consisting of polypropylene, polydimethylsiloxane and parylene.
